(19) United States
(12) Patent Application Publication
(10) Pub. No.: US 2013/0166789 A1
(43) Pub. Date: Jun. 27, 2013

(54) CONTROLLING DEVICE SETTING BASED ON DEVICE SETTING GUIDE INFORMATION

(71) Applicant: KT Corporation, Gyeonggi-do (KR)

(72) Inventors: Jung-Wook LEE, Gyeonggi-do (KR); You-Jin KANG, Seoul (KR); Seung-Woo LEE, Seoul (KR); Jae-Uk CHA, Gyeonggi-do (KR)

(73) Assignee: KT CORPORATION, Gyeonggi-do (KR)

(21) Appl. No.: 13/726,422

(22) Filed: Dec. 24, 2012

(30) Foreign Application Priority Data
Dec. 23, 2011 (KR) 10-2011-0141387

(51) Int. Cl. G06F 13/10

(52) U.S. Cl. CPC G06F 13/10
USPC 710/15

(57) ABSTRACT

The disclosure is related to controlling a device setting in user equipment. Whether the user equipment is connected to a control guide device may be detected. Device setting guide information may be obtained from a connected control guide device. The device setting of the user equipment may be controlled based on the obtained device setting guide information.

### CROSS REFERENCE TO PRIOR APPLICATIONS

The present application claims priority under 35 U.S.C. §119 to Korean Patent Application No. 10-2011-0141387 (filed on Dec. 23, 2011), which is hereby incorporated by reference in its entirety.

The subject matter of this application is related to U.S. patent application Ser. No. 13/540,112 filed Jul. 2, 2012, as Attorney Docket No.: (801.0050), U.S. patent application Ser. No. 13/539,929 filed Jul. 2, 2012, as Attorney Docket No.: (801.0051), U.S. patent application Ser. No. 13/460,091 filed Apr. 30, 2012, as Attorney Docket No.: (801.0061), U.S. patent application Ser. No. 13/598,741 filed Aug. 30, 2012, as Attorney Docket No.: (801.0081), U.S. patent application Ser. No. 13/726,361 filed Dec. 24, 2012, as Attorney Docket No.: (801.0083), U.S. patent application Ser. No. ______ filed ______, as Attorney Docket No.: (801.0085), U.S. patent application Ser. No. ______ filed ______, as Attorney Docket No.: (801.0086), U.S. patent application Ser. No. 13/726,384 filed Dec. 24, 2012, as Attorney Docket No.: (801.0087), and U.S. patent application Ser. No. 13/726,404 filed Dec. 24, 2012, as Attorney Docket No.: (801.0088), the teachings of which are incorporated herein their entirety by reference.

### FIELD OF THE INVENTION

The present invention relates to at least one of user equipment and a control guide device configured to be connected to user equipment and, in particular, to controlling a device setting of user equipment based on device setting guide information.

### BACKGROUND OF THE INVENTION

User equipment has advanced so as to perform multiple functions such as communicating voice and data with others; exchanging text messages or multimedia messages; sending e-mails; capturing a still or moving image; playing back a music or a video file, playing a game, and a receiving a broadcast signal. Lately, such multi-functional user equipment has received greater attention for new applications. Instead of using multiple independent devices, a user prefers to use single multifunction-enabled user equipment. Portability and/or mobility should be considered in design of user equipment, but such user equipment has limitations in size. Accordingly, there also are limitations in display screen size, screen resolution, and speaker performance.

In order to overcome such limitations, an external device having a large display size, better speaker performance, and connectable to a mobile terminal has been introduced. Such external device connected to the mobile terminal can provide data, music files, and other content stored in the mobile terminal in better performance.

Lately, various types of user equipment have been introduced. Such user equipment may have functions, features, and structures designed for high portability and easy operation. Since such user equipment is very convenient to carry and use, it is very popular among people, especially to kids. Due to easy operation, even kids can easily change a device setting of the user equipment and download improper games and contents. In addition, whenever user equipment is coupled to an external device, a related user may change device setting to be suitable for the coupled external device. Such operation may be annoying to a related user.

### SUMMARY OF THE INVENTION

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present invention, user equipment may control a device setting based on device setting guide information stored in a coupled device.

In accordance with another aspect of the present invention, a device setting of user equipment may be controlled according to device setting guide information stored in a device when the device is coupled to the user equipment

In accordance with still another aspect of the present invention, a control guide device may store device setting guide information for controlling a device setting of user equipment.

In accordance with an embodiment of the present invention, a method may be provided for controlling a device setting in user equipment. The method may include detecting whether the user equipment is connected to a control guide device, obtaining device setting guide information from a connected control guide device, and controlling the device setting of the user equipment based on the obtained device setting guide information.

The controlling may include setting a connected mode device setting of the user equipment based on the obtained device setting guide information, and performing at least one operation based on the set connected mode device setting.

The method may further include changing the set connected mode device setting to a standalone mode device setting when the user equipment is disconnected from the control guide device, and performing the at least one operation based on the standalone mode device setting.

The method may further include updating the set connected mode device setting, and storing setting information associated with the updated connected mode device setting in at least one of the user equipment and the control guide device.

The obtained device setting guide information may include at least one of user interface (UI) setting information, execution control information associated with at least one application to be controlled, and display setting information.

The obtained device setting guide information may further include an identification number assigned in connection with the connected user equipment.

In accordance with another embodiment of the present invention, a method may be provided for controlling a device setting in user equipment. The method may include detecting whether the user equipment is connected to a control guide device, determining whether device setting guide information associated with the user equipment is stored in a connected control guide device, configuring a connected mode device setting of the user equipment based on user input information when the device setting guide information is not stored, and performing at least one operation based on the configured connected mode device setting.

The method may further include storing setting information associated with the configured connected mode device setting in the connected control guide device.

The method may further include assigning an identification number in connection with the user equipment, and storing setting information associated with the configured connected mode device setting and the assigned identification number in the connected control guide device.

The method may further include changing the configured connected mode device setting to a standalone mode device setting when the user equipment is disconnected from the control guide device, and performing the at least one operation based on the standalone mode device setting.

In accordance with still another embodiment of the present invention, user equipment may be provided for controlling a device setting. The user equipment may include a sensing unit and a device setting control unit. The sensing unit may be configured to detect whether the user equipment is connected to a control guide device. The device setting control unit may be configured to control the device setting of the user equipment, based on at least one of device setting guide information obtained from a connected control guide device and a connected mode device setting configured according to user input information.

The device setting control unit may configure the connected mode device setting when the device setting guide information is not stored in the connected control guide device.

The device setting control unit may be further configured to store setting information associated with the configured connected mode device setting in the connected control guide device.

The device setting control unit is further configured to change a current device setting of the user equipment to a standalone mode device setting when the user equipment is disconnected from the control guide device, and to perform the at least one operation based on the standalone mode device setting.

In accordance with still another embodiment of the present invention, a control guide device may be provided for guiding a device setting control of user equipment. The control guide device may include storage unit and connection unit. The storage unit may be configured to store device setting guide information provided to a connected user equipment. The connection unit may be configured to perform a connection interface such that the stored device setting guide information is provided to the connected user equipment.

The control guide device may further include a body member configured to include the storage unit and the connection unit, wherein the body member is configured by a shock absorbing material.

The shock absorbing material may be a rubber or a rubberized plastic material.

The body member may further include a coupling bay configured to accommodate the user equipment.

The device setting guide information may include at least one of user interface (UI) setting information, execution control information associated with at least one application to be controlled, and display setting information.

The device setting guide information may further include an identification number assigned in connection with the connected user equipment.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 shows user equipment coupled to a control guide device in accordance with at least one embodiment of the present invention;

FIG. 2 is a block diagram illustrating user equipment in accordance with at least one embodiment of the present invention;

FIG. 3 is a block diagram illustrating a control guide device in accordance with at least one embodiment of the present invention;

FIG. 4 shows a port unit of user equipment in accordance with an embodiment of the present invention;

FIG. 5 shows controlling a device setting of user equipment based on device setting guide information in accordance with at least one embodiment of the present invention;

FIG. 6 shows configuring a connected mode device setting in user equipment in accordance with at least one embodiment of the present invention; and

FIG. 7 shows restoring a device setting of user equipment according to disconnection from a coupled control guide device in accordance with at least one embodiment of the present invention.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

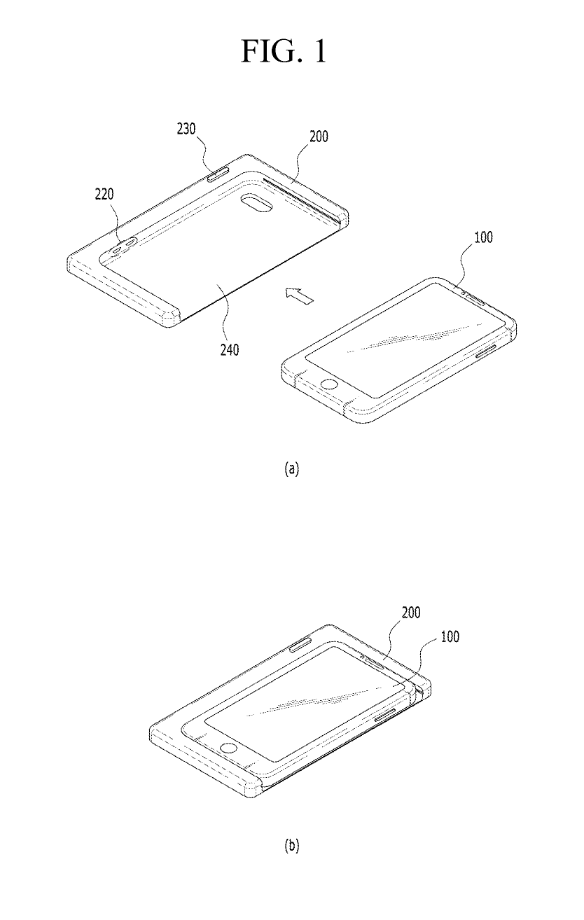

In accordance with at least one embodiment of the present invention, user equipment may control a device setting based on device setting guide information stored in a control guide device. After setting the device setting based on the device setting guide information, the user equipment may provide a user environment tailored according to a type of the coupled control guide device. Further, the device setting guide information may be preset and stored in at least one of a control guide device and user equipment. Before describing such operation, user equipment and a connectable control guide device will be described with reference to FIG. 1 to FIG. 3.

FIG. 1 shows user equipment and a control guide device in accordance with at least one embodiment of the present invention.

Referring to FIG. 1, control guide device 200 may be coupled to user equipment 100 and provide device setting guide information to user equipment 100. User equipment 100 may set device setting thereof based on the provided device setting guide information while user equipment 100 is connected to control guide device 200. Such control guide device 200 may be produced for specific purposes. For example, control guide device 200 may be manufactured for controlling user equipment 100 for kids, teenager, seniors, handicapped person, or preferred language. That is, when control guide device 200 for a kid is coupled to user equipment 100, user equipment 100 may provide a user environment suitable for a kid, such as restricting the execution of applications (e.g. installed in user equipment 100) not suitable for a kid and restricting download of games and change of a password for user equipment 100. In this case, control guide device 200 may be manufactured with a thick bumper for protecting user equipment 100 from damaged. Furthermore, when control guide device 200 for a handicapped person such as a person with bad vision, user equipment 100 may be set to display texts with a comparatively large font size. In addition, when control guide device 200 for a preferred language such as Korean, user equipment 100 may display all texts in Korean language. Such control guide device 200 may be manufactured for specific purposes such as medical equipment, navigation, a moving image player, and so forth. In this case, control guide device 200 may store applications produced for the purpose thereof. User equipment 100 may retrieve the stored application and automatically install and execute the retrieved application for operating as the medical equipment, the navigation, and the moving image player. As described, control guide device 200 may be manufactured for various purposes.

When control guide device 200 is coupled to user equipment 100, user equipment 100 may change display settings based on device setting guide information stored in control guide 200. Such device setting guide information may include device setting information for controlling user equipment 100 for the purpose of control guide device 200. Hereinafter, structures and features of control guide device 200 and a coupling manner of control guide device 200 and user equipment 100.

User equipment 100 may be coupled to an external device such as control guide device 200 in various manners. For example, user equipment 100 may be coupled to a pad type device in a docking manner as show in a diagram (A). Furthermore, user equipment 100 may be coupled to an external device such as control guide device 200 through a physical cable.

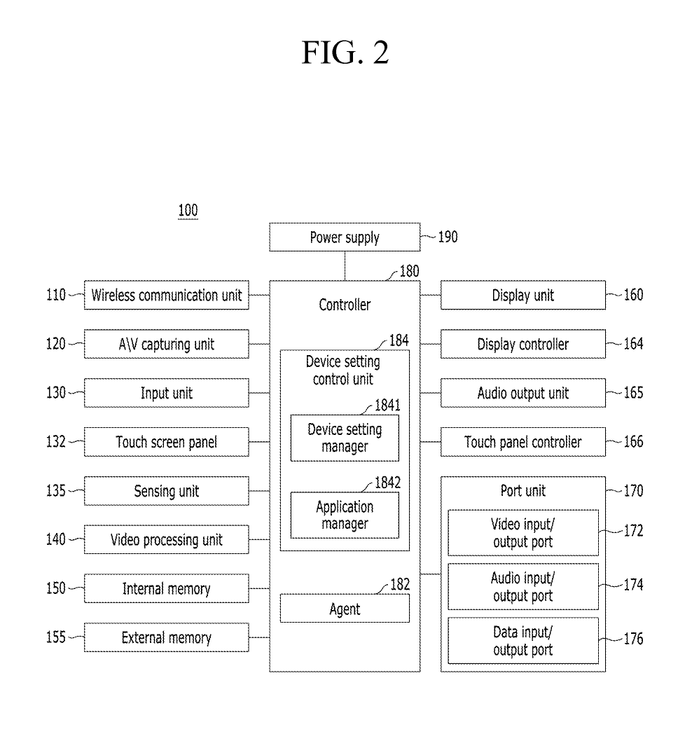

FIG. 2 is a block diagram illustrating user equipment in accordance with at least one embodiment of the present invention.

User equipment 100 may have a certain design or standardized interface connectable to an external device such as control guide device 200. For example, user equipment 100 may be attachable to and/or detachable with a cable or wireless radio from control guide device 200. User equipment 100 may dock to control guide device 200. User equipment 100 may be any electronic device that can perform the above and further operations described herein. For example, user equipment 100 may include, but is not limited to, a mobile terminal, a mobile device, a mobile phone, a portable terminal, a portable device, a handheld device, a digital broadcasting receiving device, a cellular phone, a smart phone, a personal digital assistant (PDA), wireless local loop (WLL) station, a portable multimedia player (PMP), and a navigation device. The present invention, however, is not limited thereto, and other types of user equipment, such as mini-laptop PCs and other computing devices may incorporate embodiments of the present invention.

As illustrated in FIG. 2, user equipment 100 may include wireless communication unit 110, audio/video (A/V) input unit 120, input unit 130, sensing unit 135, video processing unit 140, internal memory 150, external memory 155, display unit 160, display controller 164, audio output unit 165, touch panel controller 166, port unit 170, controller 180, and power supply 190. Input unit 130 may include touch screen panel 132. Controller 180 may include agent 182 and device setting control unit 184. Port unit 170 may include video input/output port 172, audio input/output port 174, and data input/output port 176. Power supply unit 190 may include a battery for electric charging. User equipment 100 may be described as including the above constituent elements, but the present invention is not limited thereto.

Wireless communication unit 110 may include at least one module for communicating with other party through a wireless communication system. For example, wireless communication unit 110 may include any or all of a broadcasting signal receiving module, a mobile communication module, a wireless Internet module, a short-distance communication module, and a location information module (e.g., GPS receiving module). In accordance with at least one embodiment of the present invention, wireless communication unit 110 may be not an essential unit for user equipment 100 because user equipment 100 may be not required to communicate with another party. Accordingly, wireless communication unit 110 may be omitted in accordance with another embodiment of the present invention.

A/V capturing unit 120 may capture an audio signal and/or a video signal. For example, the A/V input unit 120 may include a camera and a microphone. The camera may process image frames of a still image or a moving image, which are captured by an image sensor in a video call mode or a photographing mode. The microphone may receive an audio signal provided externally in an on-call mode, a recording mode, or a voice recognition mode.

Input unit 130 may be a user interface for receiving input (e.g., a user command) from a user. Such an input unit 130 may be realized in various types. For example, input unit 130 may include any of a keypad, a dome switch, a touch pad, a jog wheel, and a jog switch, but is not limited thereto.

In accordance with at least one embodiment of the present invention, user equipment 100 may be a full touch type smart phone. In this case, input unit 130 may include several hardware key buttons and a touch screen. The hardware key buttons may include a hold key and a volume control button. Touch screen panel 132 may be another input unit for receiving touch inputs in accordance with embodiments of the present invention. Touch screen panel 132 may be disposed on an upper surface of display unit 160, but the present invention is not limited thereto.

In accordance with at least one embodiment of the present invention, input unit 130 may be configured to receive selection inputs from a user for selecting at least one of applications. Further, input unit 130 may be configured to receive selection inputs (e.g., UI setting information, allowed/restricted applications, display setting information, etc) from a user for configuring a connected mode device setting. For example, a user may make such selection inputs based on a graphic user interface (GUI) provided to the user through display unit 160. The GUI may be displayed with a list of applications installed in user equipment 100. A device setting associated with user equipment 100 may be changed based on device setting guide information stored in at least one of control guide device 200 and user equipment 100. Changed results of the device setting may be reflected to input unit 130. Accordingly, input unit 130 may provide a variety of input UI (e.g., a menu for input).

Sensing unit 135 may detect a current status of user equipment 100. Sensing unit 135 may include various sensors such as an acceleration sensor, a proximity sensor, and/or a touch sensor. For example, sensing unit 135 may sense an opening or closing of a cover of user equipment 100, a location and a bearing of user equipment 100, acceleration and deceleration of user equipment 100, or physical contact with or proximity to a user. Based on the detected status of user equipment 100, sensing unit 135 may generate a sensing signal to control the operation of user equipment 100. For example, in the case of a mobile phone having a sliding type cover, sensing unit 135 may sense whether a cover is opened or closed. Sensing unit 135 may sense whether or not power supply 190 supplies power. Furthermore, sensing unit 135 may sense whether or not port unit 170 is coupled to an external device such as control guide device 200. In this case, sensing unit 135 may receive a detection signal from port unit 170 when user equipment 100 is connected to an external device such as control guide device 200 in accordance with an embodiment of the present invention. For example, sensing unit 135 may receive a detection signal from a hot plug detect (HPD) pin when port unit 170 includes a HDMI port. Based on the detection signal, controller 180 may determine that an external device such as control guide device 200 is connected to user equipment 100.

Video processing unit 140 may process an image signal and/or image data under the control of controller 180. Particularly, video processing unit 140 may process image data according to a display setting determined based on display unit information of display unit 160. The display setting may include a screen size, a screen resolution, a display direction, and a dot per inch (DPI) value. The display setting may be determined by controller 180 based on display unit information of display unit 160. The display unit information may include a manufacturer, a model number, a device identifier (ID), a DPI value, a screen size, the number of pixels, supporting screen resolutions, supporting aspect ratios, refresh rates, and a response time. Video processing unit 140 may transmit the processed image data to display unit 160 of user equipment 100 in response to controller 180. Furthermore, video processing unit 140 may process image data to be transmitted to an external device such as control guide device 200 (e.g., a control guide device including a display unit) when user equipment 100 is connected to the external device. For example, video processing unit 140 may, reconfigure image data based on a display setting of an external device such as control guide device 200 and generate a signal based on the reconfigured image data in response to controller 180. The present invention, however, is not limited thereto. Such an operation may be performed by controller 180. The image data may be data for displaying a graphic user interface produced by any software programs installed in user equipment 100, such as an operating system and applications installed in user equipment 100.

Internal memory 150 and external memory 155 may be used as a data storage device of user equipment 100. For example, internal memory 150 and external memory 155 may store information necessary for operating user equipment 100 and performing certain operations requested by a user. Such information may include any software programs and related data. For example, internal memory 150 and external memory 155 may store an operation system data, applications, and related data, received from an external device through a physical cable and downloaded from a related server from through a communication link. In accordance with at least one embodiment of the present invention, internal memory 150 and/or external memory 155 may store information on display setting determined for display unit 160 or a display unit of an external device. Furthermore, internal memory 150 and external memory 155 may store device unit information for candidate external devices connectable to user equipment 100. In addition, internal memory 150 and/or external memory 150 may store a DPI table (not shown). Internal memory 150 may be a flash memory, hard disk, multimedia card micro memory, SD or XD memory, Random Access Memory (RAM), Static Random Access Memory (SRAM), Synchronous dynamic random access memory (SDRAM), Read-Only Memory (ROM), Programmable Read-Only Memory (PROM), Electrically Erasable Programmable Read-Only Memory (EEPROM), magnetic memory, magnetic disk, or optical disk, but is not limited thereto. External memory 155 may be a SD card or a USB memory, but the present invention is not limited thereto. For example, an external device such as control guide device 200 may function as external memory 155 when an external device such as control guide device 200 is coupled to user equipment 100 in accordance with an embodiment of the present invention.

In accordance with embodiment of the present invention, at least one of internal memory 150 and external memory 155 may store external device information received from the connected external device, for example, control guide device 200. The external device information may include device type information and universal serial bus (USB) device information. The device type information includes information on a device type of the connected external device and the USB device information may include information on vender identification (VID) and product identification (PID) of the external device.

Further, internal memory 150 and external memory 155 may store a device table and application information. The device table may include device type information mapped to USB device information. The device table may be used to obtain the external device information. The application information may include information on whether an application is required for optimally controlling and driving constituent elements of the external device, an application type, and an address of a server for obtaining the required application. The application information may be used to determine an application required for controlling constituent element of the connected external device such as control guide device 200.

Furthermore, in at least one embodiment of the present invention, at least one of internal memory 150 and external memory 155 may store an application list, a standalone device setting state, states of operations interrupted due to a device setting change, device setting guide information (e.g., a preset device setting guide information), a retrieved/created/updated connected mode device settings, operation states performed based on a connected mode device settings, allowed/restricted application list, device information (e.g., external device information, and/or user equipment information), and so forth.

Display unit 160 may be an output device for visually displaying information. For example, display unit 160 may display image data produced or processed by video processing unit 140 and/or controller 180. Display unit 160 may receive the image data from at least one of video processing unit 140 and controller 180 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as “App”. Also, the image data may further include still images and moving images, produced or processed by video processing unit 140 and controller 180. For example, display unit 160 may be a liquid crystal display (LCD) panel or an active-matrix organic light-emitting diode (AMOLED) panel, but the present invention is not limited thereto.

In accordance with at least one embodiment of the present invention, display unit 160 may display a graphic user interface for receiving at least one user selection input (e.g., UI setting information, allowed/restricted applications, display setting information, etc.) associated with configuring a connected mode device setting. Such graphic user interface may be created by controller 180 and video processing unit 140.

Audio output unit 165 may provide an output audio signal that may be produced or processed by controller 180 as a result of operations performed by an operating system and/or applications installed in user equipment 100. Audio output unit 165 may include a speaker, a receiver, and a buzzer.

Port unit 170 may include at least one port for exchanging signals and/or data with an external device such as control guide device 200. In accordance with an embodiment of the present invention, port unit 170 may transfer image data and audio data from user equipment 100 to the external device such as control guide device 200. Port unit 170 may exchange control data with the external device such as control guide device 200. Port unit 170 may be coupled to a corresponding port unit of the external device, such as connection unit 220 of control guide device 200, in various coupling manners. For example, port unit 170 may be coupled to the corresponding port unit of the external device, such as connection unit 220 of control guide device 200, through a physical cable. Furthermore, port unit 170 may be directly interlocked with the corresponding port unit of the external device, such as connection unit 220 of control guide device 200. The present invention, however, is not limited thereto. Port unit 170 may be coupled to the corresponding port unit of the external device, such as connection unit 220 of control guide device 200, through a radio link formed between user equipment 100 and the external device such as control guide device 200. In this case, port unit 170 and the corresponding port unit (e.g., connection unit 220) may include a wireless signal transmitter and receiver (not shown) for communicating with each other using a predetermined communication protocol. Such communication protocol may be Bluetooth® or WiFi, for example, but the present invention is not limited thereto.

As shown in FIG. 2, port unit 170 may include video input/output port 172, audio input/output port 174, and data input/output port 176, but the present invention is not limited thereto. Such port unit 170 may be embodied in various types. For example, port unit 170 may not include video input/output port 172 and/or audio input/output port 174 in the case that an external device such as control guide device 200 does not include a display unit and a video output port, and/or an audio output unit and an audio output port. Further, port unit 170 may include a power port (not shown). In this case, if an external device such as control guide device 200 has a power supply, the power port may transfer power from an external device such as control guide device 200 to user equipment 100 when the external device such as control guide device 200 is coupled to user equipment 100.

In accordance with at least one embodiment of the present invention, user equipment 100 may be coupled to an external device (e.g., control guide device 200) through port unit 170. After user equipment 100 coupled to the external device (e.g., control guide device 200), user equipment 100 may control the external device (e.g., control guide device 200) by exchanging data with the external device (e.g., control guide device 200) through port unit 170. For example, user equipment 100 may receive inputs from a user through the external device (e.g., control guide device 200) and transmit control data to the external device (e.g., control guide device 200) through port unit 170. Particularly, user equipment 100 may transmit image data through port unit 170 to the external device (e.g., control guide device 200) and control the external device (e.g., control guide device 200) to display the image data such a graphic user interface instead of display unit 160 of user equipment 100. Furthermore, user equipment 100 may transmit, through port unit 160, operation results of an application tailored for optimally controlling and driving constituent elements of connected the external device (e.g., control guide device 200).

Controller 180 may control overall operation of the constituent elements of user equipment 100. Particularly, controller 180 may perform operations necessary for driving the constituent elements of user equipment 100 in response to inputs received from a related user. Controller 180 may control overall operation of constituent elements of an external device such as control guide device 200 when user equipment 100 is connected to the external device such as control guide device 200. For example, controller 180 may receive inputs through the external device such as control guide device 200, perform an operation in response to the received inputs, and provide the user with the result thereof through the external device such as control guide device 200. Particularly, controller 180 may display image data, as a result of operation related to the user inputs, on a display unit of the external device such as control guide device 200 when user equipment 100 is connected to the external device such as control guide device 200.

In order to control an external device such as control guide device 200 when user equipment 100 is connected to the external device such as control guide device 200, controller 180 may include agent 182. Agent 182 may control operations related to connection to the external device such as control guide device 200 and controlling the external device such as control guide device 200. Such agent 182 may be referred to as a coupling agent or a docking agent, but the present invention is not limited thereto. Agent 182 may be implemented in software. For example, agent 182 may be realized on an application layer in an operating system (OS) structure of user equipment 100. For example, such an OS structure may be an OS structure of an Android operating system, but present invention is not limited thereto.

In at least one embodiment of the present invention, controller 180 may include device setting control unit 184. Device setting control unit 184 may control a device setting of user equipment 100 based on device setting guide information. More specifically, the device setting control unit 184 may control (e.g., change) a device setting of user equipment 100, based on at least one of device setting guide information obtained from a connected control guide device 200 and a connected mode device setting configured according to user input information. Further, device setting control unit 184 may perform at least one operation (e.g., a user interface, an execution control of at least one application, screen display, and so forth) based on a changed device setting. Herein, the device setting guide information may include UI setting information, allowed/restricted applications, execution control information associated with at least one application, display setting information, and so forth. Sensing unit 135 may sense whether user equipment 100 is connected to an external device including control guide device 200.

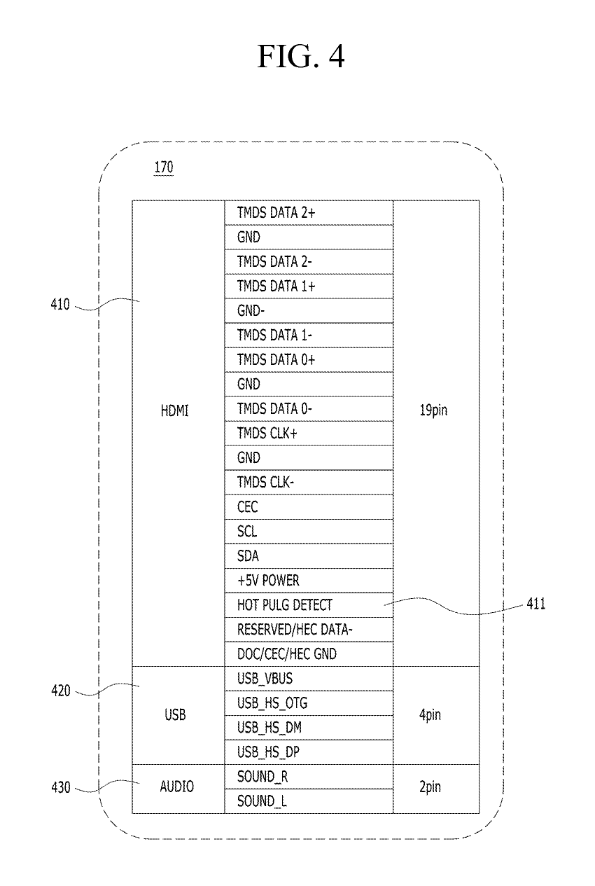

More specifically, device setting control unit 184 may include device setting manager 1841 and application manager 1842. Herein, device setting manager 1841 may change a device setting of user equipment 100, based on at least one of device setting guide information obtained from a connected control guide device 200 and a connected mode device setting configured according to user input information. Application manager 1842 may control (e.g., perform or restrict) at least one operation (e.g., an execution control of at least one application) based on a changed device setting of user equipment 100. For example, when a specific application is restricted by a changed device setting, application manager 1842 may restrict an execution of the corresponding application even though a user requests an execution of the restricted application. Device setting control unit 184 will be described in more detail with reference to FIG. 4 to FIG. 7.

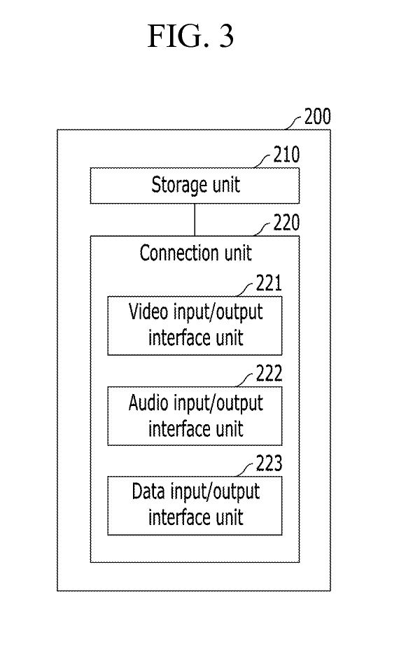

FIG. 3 is a block diagram illustrating a control guide device in accordance with at least one embodiment of the present invention.

As illustrated in FIG. 3, control guide device 200 may include storage unit 210, connection unit 220, and state indication unit 230 in accordance with at least one embodiment of the present invention. Control guide device 200 may further include a body member (i.e., an entire portion excluding storage unit 210, connection unit 220, and state indication unit 230 of control guide device 200 in FIG. 1) having coupling bay 240 (see FIG. 1). Herein, the body member may be configured to include storage unit 210 and connection unit 220. Coupling bay 240 may be configured to accommodate user equipment 100. Further, the body member may is configured by a shock absorbing material such as a rubber and/or a rubberized plastic material.

Storage unit 210 may store device setting guide information (e.g., a preset device setting guide information) and device information. The device information may be information on control guide device 200, such as a device type and an identification number. The device setting guide information may be used to set a device setting of user equipment 100 when the user equipment 100 is coupled to control guide device 200. Such device setting guide information may be preset by a manufacturer of control guide device 200, but the present invention is not limited thereto. For example, the device setting guide information may be created or updated by user equipment 100 when control guide device 200 is coupled to user equipment 100. The device setting guide information may include at least one of user interface (UI) setting information, execution control information associated with at least one application to be controlled, and display setting information. Further, the device setting guide information may include an identification number assigned in connection with user equipment 100.

In at least one embodiment of the present invention, storage unit 210 may be attachable to and/or detachable from control guide device 200. Storage unit 210 may be analogous to, and perform similar functions to, memory (e.g., internal memory 150 and/or external memory 155) of user equipment 100. Accordingly, the detailed description thereof is omitted herein.

Meanwhile, connection unit 220 may be configured to perform a connection interface such that the stored device setting guide information is provided to a connected user equipment 100. For example, connection unit 220 may be connected to port unit 170 of user equipment 100. That is, connection unit 220 may be a connecting port for forming connectivity between user equipment 100 and control guide device 200. Accordingly, connection unit 220 may be a pair relation with port unit 170 of user equipment 100. Connection unit 220 may have the same interface configuration of that of port unit 170 of user equipment 100. For example, connection unit 220 may have a HDMI port, a USB port, and an audio port.

More specifically, connection unit 220 may include video input/output interface unit 221, audio input/output interface unit 222, and data input/output interface unit 223. Video input/output interface unit 221 including a video input/output port may receive and transmit image data from/to user equipment 100. Audio input/output interface unit 222 including an audio input/output port may receive and transmit audio signals from/to user equipment 100. Data input/output interface unit 223 including a data input/output port may exchange data with user equipment 100. Furthermore, connection unit 220 may include a power port (not shown) for transferring power to user equipment 100 and a sensing port (not shown) for sensing connection formed between user equipment 100 and control guide device 200. The present invention, however, is not limited thereto. For example, connection unit 220 may be connected to user equipment 100 through a radio link formed between user equipment 100 and control guide device 200. In this case, connection unit 220 may include a signal transmitter and receiver (not shown) for communicating with each other using a communication protocol. Such communication protocol may be Bluetooth® or WiFi, for example, but the present invention is not limited thereto.

State indication unit (230, see FIG. 1) may indicate a connection state between user equipment 100 and control guide device 200, using an illumination unit such as LED.

Referring back to FIG. 1, control guide device 200 may include coupling bay 240 in accordance with at least one embodiment of the present invention. Connection unit 220 may be disposed on one side of coupling bay 240. Coupling bay 240 may be formed at a part of a side (e.g., a rear side in the case that control guide device 200 has a display unit) of control guide device 200. Coupling bay 240 may have a space for housing user equipment 100. User equipment 100 may be inserted into coupling bay 240. In accordance with at least one embodiment of the present invention, port unit 170 of user equipment 100 may be connected with connection unit 220 of control guide device 200 when user equipment 100 is completely inserted into coupling bay 240.

In at least one embodiment of the present invention, control guide device 200 may further include at least one of a display unit, an audio output unit, a touch input unit, a keypad input unit, a signal processing unit, a manager, and a power supply. In this case, the display unit, the audio output unit, the touch input unit, the keypad input unit, and the power supply unit may be analogous to, and perform similar functions to, display unit 160, audio output unit 165, input unit 130, and power supply unit 190 of user equipment 100. Accordingly, the detailed description thereof will be omitted herein. For convenience and ease of understanding, only constituent elements performing distinct operations are described.

The manager may control overall operation for controlling constituent elements of connection unit 220 in response to user equipment 100 when connection unit 220 is coupled to user equipment 100. In accordance with at least one embodiment of the present invention, the manager may receive control data from user equipment 100 through connection unit 220 and perform operation in response to the control data. Further, the manager may receive inputs from a related user and transmit the received input to user equipment 100 through connection unit 220.

Furthermore, the manager may provide control guide device information to user equipment 100 when external device 200 is connected to user equipment 100. The control guide device information may include at least one of device type information and USB device information. User equipment 100 may identify a device type of control guide device 200 based on the control guide device information and run an application determined based on the device type of control guide device 200. Such application may produce operation results optimized for constituent elements of control guide device 200. The manager may receive such operation results from user equipment 100 and control constituent elements of control guide device 200 based on the received operation results in accordance with embodiments of the present invention. Furthermore, the manager may control related constituent elements to output the received operation results in accordance with embodiments of the present invention.

In accordance with an embodiment of the present invention, control guide device 200 may not operate in a disconnected status. The disconnected status may denote that user equipment 100 is not connected to control guide device 200. Accordingly, control guide device 200 may be a dummy device. In this case, control guide device 200 may include minimum elements for performing essential functions such as display control and touch input control. The present invention, however, is not limited thereto. Control guide device 200 may be embodied as an independent device installed with an operating system (OS) that allows control guide device 200 operating in a standalone device. For example, control guide device 200 may operate as a moving image player or a MP3 player when control guide device 200 is not coupled to user equipment 100. When control guide device 200 is coupled to user equipment 100, control guide device 200 may perform certain operations of user equipment 100 in response to the control of user equipment 100 in accordance with at least one embodiment of the present invention.

FIG. 4 shows a port unit of user equipment in accordance with an embodiment of the present invention.

Referring to FIG. 4, port unit 170 of user equipment 100 may include HDMI port 410, USB port 420, and audio port 430. HDMI port 410 may include 19 pins for exchanging signals designated to each pin. For example, HDMI port 410 may include hot plug detect (HPD) pin 411. HPD pin 411 may generate a detection signal when user equipment 100 is connected to control guide device 200. Based on the detection signal generated by HPD pin 411, user equipment 100 may determine that user equipment 100 is connected to control guide device 200. HDMI port 410 may mainly exchange image data with control guide device 200. USB port 420 may include 4 pins for mainly exchanging data with control guide device 200. Furthermore, audio port 430 may include 2 pins for exchanging audio data with control guide device 200. Although FIG. 4 shows port unit 170 having HDMI port 410, USB port 420, and audio port 430 to connect user equipment 100 with control guide device 200, the present invention is not limited thereto.

In accordance with at least one embodiment of the present invention, user equipment 100 is coupled with control guide device 200 though port unit 170 provided therein. The present invention, however, is not limited thereto. For example, user equipment 100 may be coupled to an external device such as electronic devices or appliances having such HDMI port and/or USB port to output audio/video signals thereto.

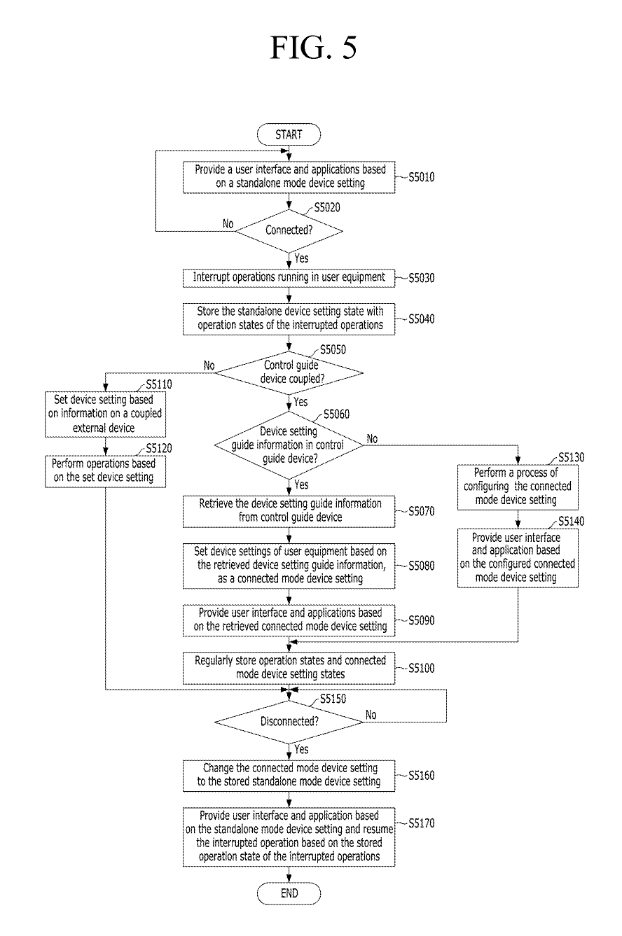

As described, user equipment may change a device setting based on a preset device setting guide information stored in a control guide device and perform operations (e.g., a user interface, an application execution control) based on the changed device setting while the control guide device is connected to the user equipment in accordance with at least one embodiment of the present invention. Such operation will be described in detail with reference to FIG. 5 to FIG. 7.

FIG. 5 shows controlling a device setting of user equipment based on device setting guide information in accordance with at least one embodiment of the present invention.

Referring to FIG. 5, user equipment 100 may provide a user interface and at least one application based on a standalone mode device setting at step S5010. Herein, the standalone mode device setting may denote a device setting for user equipment operating in a standalone mode. Based on the standalone mode device setting, user equipment 100 may display a user interface tailored according to a user on display unit 160 and further display at least one application installed or selected by the user, within the user interface. Such a standalone mode device setting may include overall settings for configuring a user interface with at least one application, such as a background image, a color scheme, a size and a position of each icon associated respective applications, and so forth.

At step S5020, user equipment 100 may determine whether user equipment 100 is coupled to an external device including control guide device 200. For example, when user equipment 100 is coupled to the external device, port unit 170 may generate a detection signal (i.e., a connection detected signal). Accordingly, user equipment 100 may detect connection to an external device (e.g., control guide device 200) based on a detection signal generated at port unit 170 of user equipment 100. That is, upon the generation of the detection signal, user equipment 100 may notice that the external device is coupled thereto. As shown in FIG. 4, port unit 170 may include HDMI port 410. In this case, hot plug detect (HPD) pin 411 of HDMI port 410 may generate a HPD signal when HDMI port 410 of user equipment 100 is coupled (e.g., directly coupled) to connection unit 220 of control guide device 200. The generated HPD signal may be transferred to agent 182 of user equipment 100. Upon the receipt of the HPD signal, agent 182 may determine that control guide device 200 is connected to user equipment 100. The present invention, however, is not limited thereto. User equipment 100 may detect connection to an external device (e.g., control guide device 200) based on communication with the external device. In at least one embodiment of the present invention, port unit 170 may include USB port 420 as shown in FIG. 4. In this case, user equipment 100 may communicate with control guide device 200 through USB port 420 when user equipment 100 is connected to control guide device 200. Particularly, user equipment 100 may communicate with control guide device 200 through a USB net and/or an android debug bridge (ADB). In summary, agent 182 of user equipment 100 may detect connection to an external device (e.g., control guide device 200) through a hardware signal scheme (e.g., a scheme detecting a connection based on a HPD signal) and/or a specific communication scheme (e.g., a scheme detecting a connection by exchanging a request message and a response message).

When the external device such as control guide device 200 is connected to user equipment 100 (Yes—S5020), user equipment 100 may interrupt operations (e.g., an application execution) that are currently running therein at step S5030.

At step S5040, user equipment 100 may store the standalone device setting state with operation states of the interrupted operations. That is, user equipment 100 may store the standalone device setting state and the operation states of the interrupted operations, in internal memory 150 and/or external memory 155.

At step S5050, user equipment 100 may determine whether the coupled external device is control guide device 200. For determination, user equipment 100 may obtain device information from the coupled external device. Control guide device 200 may include information on a device type and an identification number. Accordingly, based on the obtained information, user equipment 100 may be enabled to determine whether the coupled external device is control guide device 200 or not.

When the coupled external device is control guide device 200 (Yes—5050), user equipment 100 may determine whether coupled control guide device 200 includes device setting guide information associated with user equipment 100 at step S5060. For example, user equipment 100 may determine whether the device setting guide information associated with user equipment 100 is stored in control guide device 200. Further, agent 182 of user equipment 100 may identify whether the device setting guide information associated with user equipment 100 is stored in control guide device 200, through a communication link formed between port unit 170 of user equipment 100 and connection unit 220 of control guide device 200.

Herein, the device setting guide information may include at least one of user interface setting information, execution control information associated with at least one application, and display setting information. User interface setting information may include setting information associated with a background screen (i.e., an idle screen), a font style, a font size, a font type, an icon type, an icon size, an icon shape, an icon arrangement, an icon position, a color scheme, a sound type, a sound volume, a menu contents, a menu size, a menu style, and so forth. The execution control information associated with at least one application may include information (e.g., an allowed application list, and/or a restricted application list) on applications to be allowed/restricted, content rating (e.g., a film rate) to be allowed/restricted, and/or restricted/allowed URL information. Herein, an application may include a widget and/or a gadget. The display setting information may include a DPI value, a screen size and/or a screen display direction. In at least one embodiment of the present invention, user interface setting information may be used as a broad definition including the display setting information.

When coupled control guide device 200 includes (e.g., stores) the device setting guide information associated with user equipment 100 (Yes—S5060), user equipment 100 may retrieve the device setting guide information from control guide device 200 at step S5070. For example, user equipment 100 may retrieve a corresponding device setting guide information based on an identification number. In at least one embodiment of the present invention, the device setting guide information may be stored in user equipment 100. In this case, when control guide device 200 is coupled to user equipment 100, user equipment 100 may retrieve corresponding device setting guide information associated with coupled control guide device 200.

At step S5080, user equipment 100 may set a device setting based on the retrieved device setting guide information, as a connected mode device setting. For example, in the case that a user is an old person or a kid, the device setting guide information may include information on an idle screen, an icon type, an icon size, and/or a font size which are suitable for old users or kids.

At step S5090, user equipment 100 may provide a user interface and preselected applications based on the connected mode device setting. For example, user equipment 100 may display a user interface with the preselected applications, which are tailored according to a type of control guide device 200.

At step S5100, while providing the user interface with the preselected applications according to the connected mode device setting, user equipment 100 may regularly store states of the connected mode device setting. For example, while providing the user interface and the preselected applications based on the connected mode device setting, a user may move icons associated with the preselected applications and change display setting for the user interface. Such changes may be regularly stored for further use. For example, such changes may be stored periodically or whenever the change happens. Further, such changes may be stored in at least one of user equipment 100 (e.g., internal memory 150 and/or external memory 155) and control guide device 200 (e.g., storage unit 210).

Meanwhile, when the coupled external device is not control guide device 200 (No—5050), user equipment 100 may set device setting based on information on a coupled external device at step S5110. When other types of external devices are coupled to user equipment 100, user equipment 100 may obtain device information from the coupled external device and set a device setting based on the obtained device information. For example, when the coupled external device is a large screen monitor, user equipment may set a display setting suitable for the large screen monitor based on the device information obtained from the large screen monitor.

At step S5120, after setting, user equipment 100 may perform operations based on the device setting based on the obtained device information from the coupled external device.

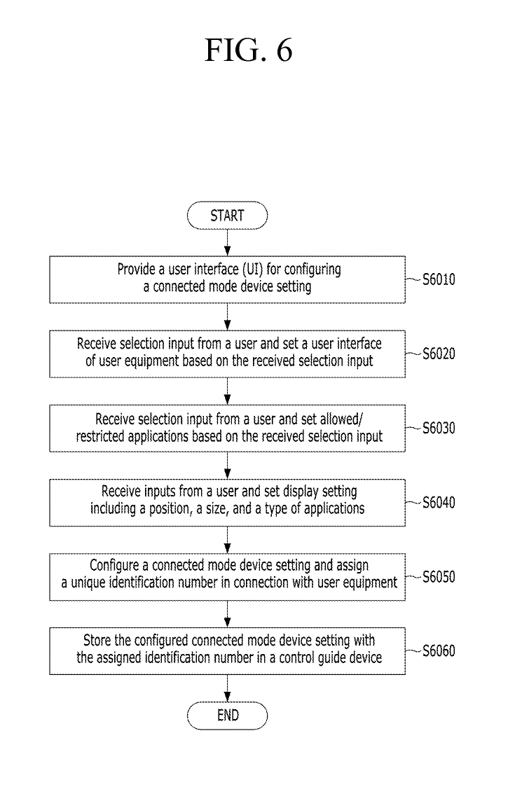

Meanwhile, when coupled control guide device 200 does not include the device setting guide information associated with user equipment 100 (No—S5060), user equipment 100 may perform a process of configuring the connected mode device setting at step S5130. For example, user equipment 100 may provide a graphic user interface for setting display setting associated with control guide device 200. Such configuration operation will be described in more detail with reference to FIG. 6.

At step S5140, after the configuration process (S5130) is performed, user equipment 100 may provide user interface and application based on the configured connected mode device setting. For example, user equipment 100 may display a user interface (e.g., a graphic user interface) with preselected applications based on the configured connected mode device setting. After performing an operation of step S5140, user equipment 100 may proceed to step S5100.

At step S5150, user equipment 100 may detect disconnection from the coupled device including control guide device 200 or the other types of external devices in response to a disconnection detected signal from a connection interface. For example, user equipment 100 may detect decoupling or de-decking from the coupled device (e.g., control guide device 200 or the other types of external device). Herein, the disconnection detected signal may be a device release signal made by port unit 170, but the invention is not limited thereto.

When user equipment 100 is disconnected from the coupled device (e.g., control guide device 200 or the other types of external device) (Yes—S5150), user equipment 100 may change the connected mode device setting to the stored standalone mode device setting at step S5160. That is, in response to such disconnection detected signal, user equipment 100 may change the connected mode device setting to the stored standalone mode device setting such that user equipment 100 moves back to an original setting state.

At step S5170, based on the restored standalone mode device setting, user equipment 100 may provide a user interface and applications and resume the interrupted operation based on the stored operation state of the interrupted operations.

FIG. 6 shows configuring a connected mode device setting in user equipment in accordance with at least one embodiment of the present invention.

Referring to FIG. 6, user equipment 100 may provide a user interface (UI) for configuring a connected mode device setting at step S6010. For example, user equipment 100 may provide a menu (“a device setting menu”) for configuring a connected mode device setting. Herein, the device setting menu may be provided in a pop-up type. In at least one embodiment of the present invention, the device setting menu may be included in a configuration menu (“OS configuration menu”) which is provided by an operating system (OS) of user equipment 100. In this case, a link between the device setting menu and the OS configuration menu may be provided in a pop-up type.

At step S6020, user equipment 100 may receive selection inputs from a user and then set a user interface of user equipment 100 based on the received selection input. For example, user equipment 100 may provide a list of different types of user interfaces through the device setting user interface. A user may select one of user interfaces included in the list as a user interface for the connected mode device setting. User equipment 100 may receive selection inputs from the user through the provided device setting user interface.

At step S6030, user equipment 100 may receive selection input from the user and set allowed/restricted applications based on the received selection input. For example, user equipment 100 may provide a list of applications through the device setting user interface. A user may select at least one of applications included in the list as applications to be allowed/restricted. User equipment 100 may receive selection inputs from the user through the provided device setting user interface. Applications to be allowed/restricted may be determined or classified based on at least one of an application category, an application type, an application property, an application group, an application content, and an application rate.

At step S6040, user equipment 100 may receive inputs from the user and then set display setting including a position, a size, and/or a type of applications.

At step S6050, user equipment 100 may configure a connected mode device setting and assign a unique identification number in connection with user equipment 100. More specifically, user equipment 100 may configure the connected mode device setting based on at least one of the selected user interface (S6020), the selected application to be allowed/restricted (S6030), and the configured display setting, which are tailored according to a device type (such as for kids, teenager, old persons or medical device, and so forth) (S6040). After configuration, user equipment 100 may assign a unique identification number to the connected mode device setting in connection with user equipment 100. Since control guide device 200 can be coupled to multiple user equipment, it might be necessary to store the configured connected mode device setting in connection with each user equipment. In at least one embodiment of the present invention, a connected mode device setting may be applied to a plurality of user equipment or one specific user equipment. In the case that user equipment 100 is capable of being connected to a plurality of control guide devices, connected mode device settings may be different according to control guide devices. In this case, the same identification number may be assigned to a pair of user equipment and control guide device, and/or a pair of user equipment and connected mode device setting.

At step S6060, user equipment 100 may store the configured connected mode device setting with the assigned identification number in a control guide device such as control guide device 200. For example, user equipment 100 may store the configured connected mode device setting as device setting guide information with the assigned identification number in a storage unit 210 of coupled control guide device 200. In at least one embodiment of the present invention, the assigned identification number may be included in the device setting guide information.

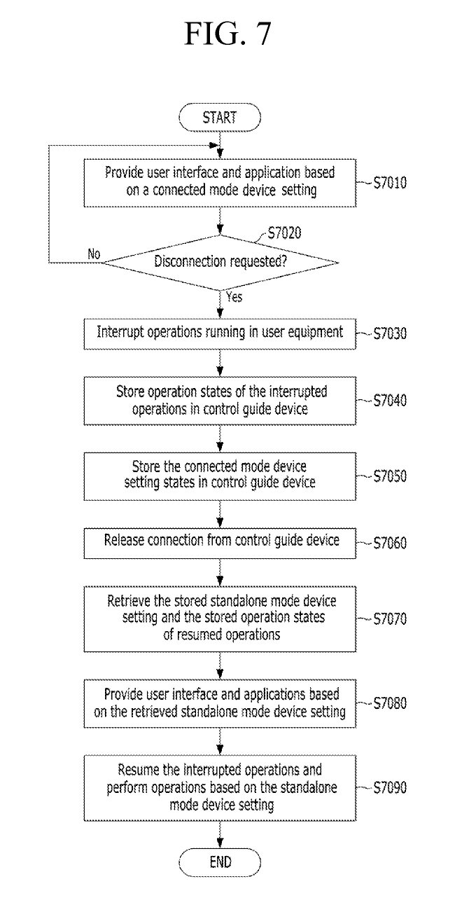

FIG. 7 shows restoring a device setting of user equipment according to disconnection from a coupled control guide device in accordance with at least one embodiment of the present invention.

Referring to FIG. 7, user equipment 100 may provide user interface and application based on a connected mode device setting at step S7010. That is, when user equipment 100 is coupled to control guide device 200, user equipment 100 may provide a user interface and preselected applications based on the connected mode device setting.

At step S7020, user equipment 100 may receive a request for disconnection when a user wants to save current states of the connected mode device setting before disconnecting control guide device 200 from user equipment 100. For example, such request may be invoked by activating a designated icon displayed with the user interface or a button (e.g., a menu button) provided on user equipment 100.

At step S7030, when receiving the disconnection request (Yes—S7020), user equipment 100 may interrupt operations that are currently running in user equipment 100.

At step S7040, user equipment 100 may store operation states of the interrupted operations in control guide device 200. More specifically, user equipment 100 may store the operation states of the interrupted operations in storage unit 210 of control guide device 200.

Further, at step S7050, user equipment 100 may store the connected mode device setting states in control guide device 200. More specifically, user equipment 100 may store the current states of the connected mode device setting in storage unit 210 of control guide device 200. In at least one embodiment of the present invention, user equipment 100 may update a device setting guide information stored in control guide device 200, based on the current states of the connected mode device setting. However, in at least one embodiment of the present invention, in the case that control guide device 200 is a control guide device for a specific user (e.g., kids), user equipment 100 may restrict an update of the device setting guide information stored in control guide device 200.

At step S7060, after the storing processes (S7040 and S7050) are performed, user equipment 100 may release connection from control guide device 200. Although coupled control guide device 200 is not disconnected (e.g., not physically disconnected), user equipment 100 may operate in a standalone mode after releasing the connection.

At step S7070, user equipment 100 may retrieve the stored standalone mode device setting and the stored operation states of interrupted operations. For example, user equipment 100 may retrieve the stored standalone mode device setting and the stored operation state of interrupted operations from own memory such as internal memory 150 and/or external memory 155.

At step S7080, user equipment 100 may provide a user interface and applications based on the retrieved standalone mode device setting. Such user interface and applications may be set by a related user while the user uses user equipment 100 in the standalone mode.

At step S7090, user equipment 100 may resume the interrupted operations and perform operations based on the retrieved standalone mode device setting. For example, user equipment 100 may resume the interrupted operations based on the stored operation state of the interrupted operations. Further, user equipment 100 may perform new operations based on the retrieved standalone mode device setting.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling a device setting in user equipment, the method comprising:
detecting whether the user equipment is connected to a control guide device;
obtaining device setting guide information from a connected control guide device; and
controlling the device setting of the user equipment based on the obtained device setting guide information.

2. The method of claim 1, wherein the controlling includes:
setting a connected mode device setting of the user equipment based on the obtained device setting guide information; and
performing at least one operation based on the set connected mode device setting.

3. The method of claim 2, further comprising:
changing the set connected mode device setting to a standalone mode device setting when the user equipment is disconnected from the control guide device; and
performing the at least one operation based on the standalone mode device setting.

4. The method of claim 2, further comprising:
updating the set connected mode device setting; and
storing setting information associated with the updated connected mode device setting in at least one of the user equipment and the control guide device.

5. The method of claim 1, wherein the obtained device setting guide information includes at least one of user interface (UI) setting information, execution control information associated with at least one application to be controlled, and display setting information.

6. The method of claim 5, wherein the obtained device setting guide information further includes an identification number assigned in connection with the connected user equipment.

7. A method of controlling a device setting in user equipment, the method comprising:
detecting whether the user equipment is connected to a control guide device;
determining whether device setting guide information associated with the user equipment is stored in a connected control guide device;
configuring a connected mode device setting of the user equipment based on user input information when the device setting guide information is not stored; and
performing at least one operation based on the configured connected mode device setting.

8. The method of claim 7, further comprising:
storing setting information associated with the configured connected mode device setting in the connected control guide device.

9. The method of claim 7, further comprising:
assigning an identification number in connection with the user equipment; and
storing setting information associated with the configured connected mode device setting and the assigned identification number in the connected control guide device.

10. The method of claim 7, further comprising:
changing the configured connected mode device setting to a standalone mode device setting when the user equipment is disconnected from the control guide device; and
performing the at least one operation based on the standalone mode device setting.

11. A user equipment for controlling a device setting, the user equipment comprising:
a sensing unit configured to detect whether the user equipment is connected to a control guide device; and
a device setting control unit configured to control the device setting of the user equipment, based on at least one of device setting guide information obtained from a connected control guide device and a connected mode device setting configured according to user input information.

12. The user equipment of claim 11, wherein the device setting control unit configures the connected mode device setting when the device setting guide information is not stored in the connected control guide device.

13. The user equipment of claim 12, wherein the device setting control unit is further configured to:
store setting information associated with the configured connected mode device setting in the connected control guide device.

14. The user equipment of claim 11, wherein the device setting control unit is further configured to:
change a current device setting of the user equipment to a standalone mode device setting when the user equipment is disconnected from the control guide device; and
perform the at least one operation based on the standalone mode device setting.

15. A control guide device for guiding a device setting control of user equipment, the control guide device comprising:
storage unit configured to store device setting guide information provided to a connected user equipment; and
connection unit configured to perform a connection interface such that the stored device setting guide information is provided to the connected user equipment.

16. The control guide device of claim 15, further comprising:
a body member configured to include the storage unit and the connection unit,
wherein the body member is configured by a shock absorbing material.

17. The control guide device of claim 16, wherein the shock absorbing material is a rubber or a rubberized plastic material.

18. The control guide device of claim 16, wherein the body member further includes:
a coupling bay configured to accommodate the user equipment.

19. The control guide device of claim 16, wherein the device setting guide information includes at least one of user interface (UI) setting information, execution control information associated with at least one application to be controlled, and display setting information.

20. The control guide device of claim 15, wherein the device setting guide information further includes an identification number assigned in connection with the connected user equipment.
